(19) United States
(12) Patent Application Publication
(10) Pub. No.: US 2026/0072801 A1
(43) Pub. Date: Mar. 12, 2026

(54) ENHANCED THERMAL MANAGEMENT CONTROL FOR UNMANAGED COMPONENTS VIA A BASEBOARD MANAGEMENT CONTROLLER

(71) Applicant: Microsoft Technology Licensing, LLC, Redmond, WA (US)

(72) Inventors: Kiran Bangalore SATHYANARAYANA, Bengaluru (IN); Rajendra KOLLI, Hyderabad (IN); Chitkala SETHURAMAN, Dublin, CA (US)

(21) Appl. No.: 18/830,547

(22) Filed: Sep. 10, 2024

(51) Int. Cl. G06F 11/30; G06F 1/20; G06F 9/30

(52) U.S. Cl. CPC G06F 11/3058; G06F 1/206; G06F 9/30083

(57) ABSTRACT

The disclosed techniques provide enhanced thermal management control for unmanaged components of a host system via a baseboard management controller (“BMC”). The techniques disclosed herein utilize a schema that defines parameters for controlling the collection of temperature data from temperature sensors inside unmanaged components. The schema enables a host agent of the host system to coordinate with the BMC and communicate temperature data acquired from unmanaged components to the BMC. Once the BMC receives the temperature data, the BMC communicates the temperature data to a control profile to accurately control the cooling level of one or more cooling units in the host system.

### BACKGROUND

As advances are made in cloud computing and data storage, the hardware and facilities required to effectively store, manage, and process data continue to grow, both in terms of facility size and the energy needed to power server hardware. Accordingly, the operating costs of data centers continues to increase. Owners of data centers have also become increasingly mindful of the ecological impact their data storage and processing operations have on the environment. As a result, companies managing data centers continue to seek more efficient ways to manage and operate data center facilities. One area of particular interest is increasing the efficiency of thermal management of server hardware.

Thermal management techniques for server hardware are continually being developed to reduce the associated energy consumption, environmental impact, cost, and noise. Some existing thermal management techniques include monitoring temperature data associated with the internal components of a host system and communicating that temperature data to a separate computer known as a baseboard management controller (“BMC”) within the host system. The BMC processes temperature data associated with the internal components of the host system and makes appropriate adjustments to a cooling unit.

One technical challenge of existing thermal control techniques is the inability of the BMC to directly access temperature data from certain components within the host system. Each component of a server can be broadly categorized as either a managed component or an unmanaged component. Managed components are directly accessible by the BMC via communication pathways within the host system, and the BMC can directly receive temperature data from these components. Unmanaged components are not directly accessible by the BMC, and the BMC cannot directly receive temperature data from these components. The inability of the BMC to directly receive temperature data from unmanaged components means unmanaged components are more difficult to cool efficiently because the temperature data used by the BMC to adjust a cooling unit is often incomplete or inaccurate.

To compensate for the above-described issues, traditional host systems have attempted to mitigate communication shortcomings between the BMC and unmanaged system components by placing managed proximity sensors near the unmanaged components of the host system. These proximity sensors allow the BMC to estimate the temperatures of unmanaged components based on readings taken from near the unmanaged components. While these proximity sensors provide the BMC with additional temperature data to improve thermal management of the host system, proximity sensor readings are still not as accurate as temperature data produced by the internal sensors of managed components. Additionally, adding proximity sensors to the host system increases the cost and complexity of the host system.

The inaccuracy of the unmanaged component temperature data received from the proximity sensors means it is not uncommon for a traditional host system to be tested in a controlled environment so a control profile can be manually configured before a host system is deployed. For example, during the platform development process, e.g., a manufacturing process, a host system can be run with various component configurations, with a cooling unit set at varying levels, to manually generate a control profile that accounts for the inaccuracies of measuring unmanaged component temperatures with proximity sensors. The manually configured control profile specifies cooling levels of a cooling unit for specific temperature measurements and is used by the BMC to thermally manage the host system after the host system has been deployed to a data center.

Although the above-described configuration process allows host systems to operate in data centers, there is an unavoidable level of inaccuracy that results from the temperature data the BMC receives from proximity sensors. Additionally, a host system may be deployed to a data center location where environmental conditions (e.g., temperature, air pressure, or humidity) differ from what was simulated in the controlled environment during the platform development process. The inherent inaccuracies of proximity sensor data, combined with potential differences in tested and real-world environmental conditions, require that a margin of error be built into any manually configured control profile to ensure the level of cooling is always sufficient to avoid thermal damage to components of the host system. This margin of error results in an overcooling of the host system and an unnecessary expenditure of energy, which increases the operational cost of data center servers and the carbon footprint of the data center itself.

Another technical challenge of existing server thermal control techniques involves the installation or removal of components after a system has been deployed. Adding or removing components after the system has been deployed may require changes to the code of the BMC or any corresponding host service to maintain thermal control of the reconfigured host system. These changes can lead to costly delays in the operation of the host system in the form of downtime due to system reboots or interruptions to services (e.g., remote monitoring and management) during firmware re-spins.

### SUMMARY

To address the challenges of acquiring temperature data from unmanaged components, improving cooling efficiency within a host system, and avoiding downtime associated with changes to the components of the host system, the disclosed techniques provide enhanced thermal management control for unmanaged components of a host system via a baseboard management controller (“BMC”). The techniques disclosed herein utilize a schema that defines parameters for controlling the collection of temperature data from the internal temperature sensors of unmanaged components. The schema enables a host agent of the host system to coordinate with the BMC and communicate temperature data acquired from unmanaged components to the BMC. Once the BMC receives the temperature data, the BMC communicates the temperature data to a control profile to accurately control the cooling level of one or more cooling units in the host system.

The schema enables coordination between the host system and the BMC by defining parameters for collecting temperature data from unmanaged components of the host system. In particular, the parameters of the schema define identifiers of the unmanaged components of the host system, interfaces from which the host agent can receive temperature data from the unmanaged components, poll frequencies specifying how often temperature data is received from the unmanaged components, and identifiers for memory objects in the memory of the BMC that store the temperature data received from the host agent.

In some embodiments, both the memory of the host system and the memory of the BMC receive a copy of the schema. The schema copies are equivalent and coordinated such that a host agent reads temperature data from unmanaged components at the host-system-level according to the host schema copy (the “host schema”) and communicates the temperature data to the BMC. The BMC then stores the temperature data in one or more memory objects according to the BMC schema copy (the “BMC schema”). The control profile can access the temperature data in the memory objects of the BMC using the same processes used to read temperature data from physical temperature sensors. Virtualized exposure of temperature data from unmanaged components to the control profile enables more accurate and efficient cooling of the host system, as the temperature data acquired from the internal sensors of unmanaged components more accurately reflects the cooling needs of the components than temperature data obtained from nearby proximity sensors. Coordination of the schema stored at the host and at the BMC also allows the host agent and the BMC to validate the communication of any temperature data sent from the host agent to the BMC by comparing the parameters of the data received from the host agent with the parameters of the data the BMC expected to receive.

Additionally, the schema is configured in such a way that it can be integrated into existing host systems that utilize current communication protocols between host systems and BMCs without requiring modification to either a host system or a BMC. This backward compatibility means the techniques described herein can be readily applied to existing host systems without costly downtime or modification to data center servers.

As described in more detail below, upon start of the runtime execution of the host agent, the host agent reads the host schema to acquire the parameters that control how the host agent reads the temperature data from unmanaged components, when the host agent communicates the temperature data to the BMC, and in which memory object or objects the host agent stores the temperature data in the memory of the BMC. The host schema file can be either a file uploaded by a user, or a default “golden schema” file stored in the host system. The golden schema specifies a minimum set of unmanaged components expected to be present in every operational host system. After reading the schema, the host agent reads the unmanaged component temperature data through at least one interface defined by the host schema at a frequency also defined by the host schema. The host agent then communicates the temperature data to the appropriate memory object in the BMC according to the host schema. The memory object functions as a virtual temperature sensor that the control profile can read as if it were a physical temperature sensor. If communication of the temperature data from the host agent to the BMC is unsuccessful, the host agent logs error message telemetry and waits for the next poll frequency. If the host agent successfully communicates the temperature reading of the unmanaged component to the BMC, the BMC processes the temperature data according to the BMC schema and communicates the temperature data to a control profile in the memory of the BMC to adjust a cooling level of a cooling unit. The host agent then waits for the next poll frequency to acquire the next instance of unmanaged component temperature data to repeat the process.

Upon start of the operational state of the BMC, the BMC reads the BMC schema file. The BMC schema file can be either a file uploaded by a user, or a default “golden schema” file stored in the firmware of the BMC. The golden schema specifies a minimum set of unmanaged components expected to be present in every operational host system. The BMC spawns sensor reading threads according to the BMC schema and waits to receive temperature data from the host agent. If the BMC does not successfully receive the temperature data from the host agent in accordance with the BMC schema, e.g., due to an error timeout, the BMC indicates an error status for the control profile and logs an error SEL, which cause the cooling unit to take mitigating action to avoid thermal damage to the host system. If the BMC successfully receives the temperature data from the host agent in accordance with the BMC schema, the BMC feeds the temperature data to the control profile. The control profile then processes the temperature data according to the BMC schema and makes any necessary adjustment to the cooling level of the cooling unit.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1A is a block diagram of a system providing enhanced thermal management control for unmanaged components via a baseboard management controller, the system in a state where a host agent exists as part of a host system interface and is communicating temperature data from the host system to the BMC in accordance with a schema.

FIG. 1B is a block diagram of a system for providing enhanced thermal management control for unmanaged components via a baseboard management controller, the system in a state where a host agent exists as part of a hardware component of the host system and is communicating temperature data from the host system to the BMC in accordance with a schema.

FIG. 1C is a block diagram of a system for providing enhanced thermal management control for unmanaged components via a baseboard management controller, the system in a state where a host agent exists within the memory of a host system and is communicating temperature data from the host system to the BMC in accordance with a schema.

FIG. 2A shows temperature data from an unmanaged component moving from a host system to a BMC in accordance with parameters defined in a schema.

FIG. 2B shows temperature data from sensors external to a host system moving into the host system and to a BMC in accordance with parameters defined in a schema.

FIG. 3 shows a control profile in the memory of the BMC using temperature data to adjust a cooling level of a cooling unit, resulting in changes to the power draw and noise output of the cooling unit.

FIG. 4A is a flow diagram showing aspects of a routine for a host agent reading temperature data from unmanaged components of a host system according to a schema.

FIG. 4B is a flow diagram showing aspects of a routine for placing a schema file in the memory of a host system where a host agent reads it.

FIG. 5A is a flow diagram showing aspects of a routine for a BMC receiving temperature data from unmanaged components of a host system according to a schema and feeding the temperature data to a control profile of a cooling unit.

FIG. 5B is a flow diagram showing aspects of a routine for placing a schema file in the memory of a BMC where the BMC reads it.

FIG. 6 shows a cooling function of a control profile that specifies a relationship between temperature data and a cooling level of a cooling unit.

FIG. 7 shows JSON data related to schema parameters for enhanced thermal management control for unmanaged components in a host system.

### DETAILED DESCRIPTION

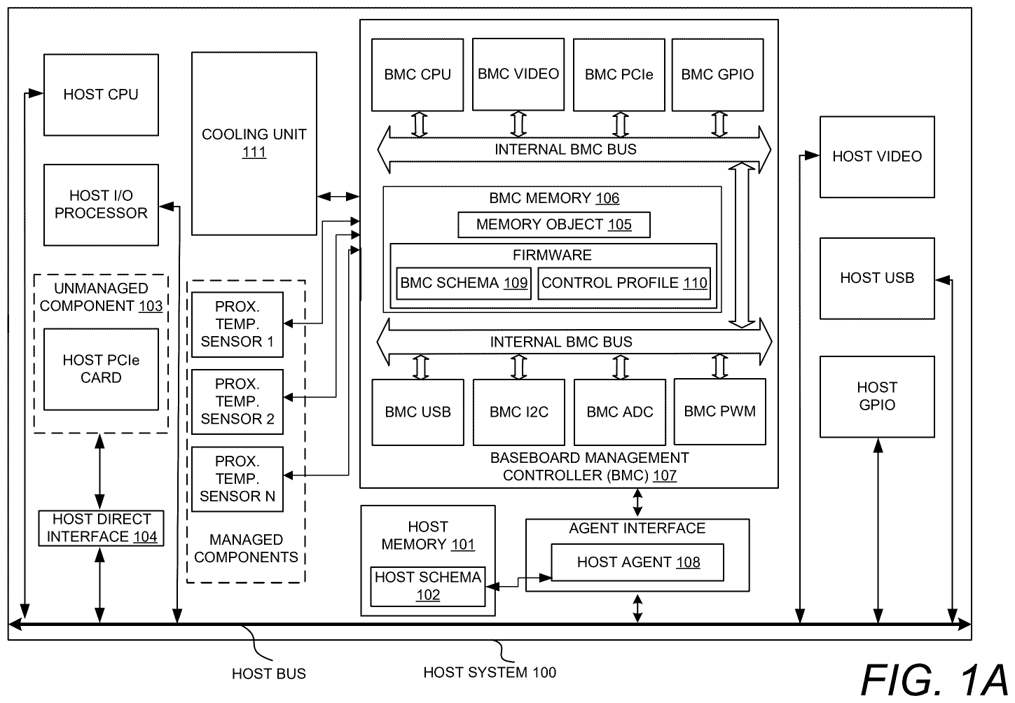

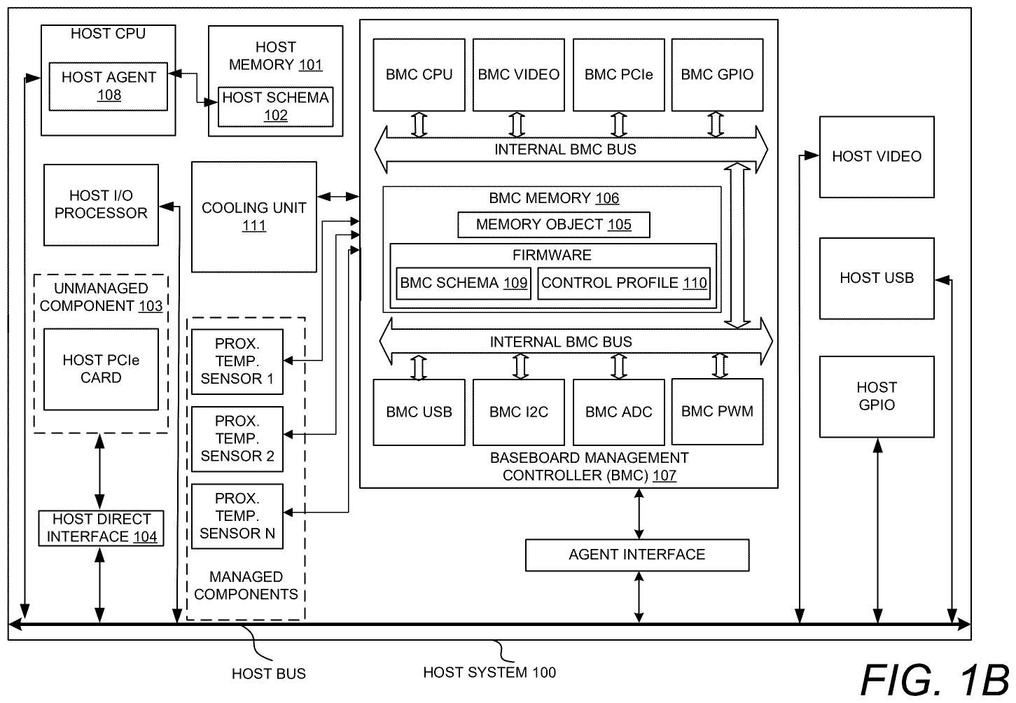

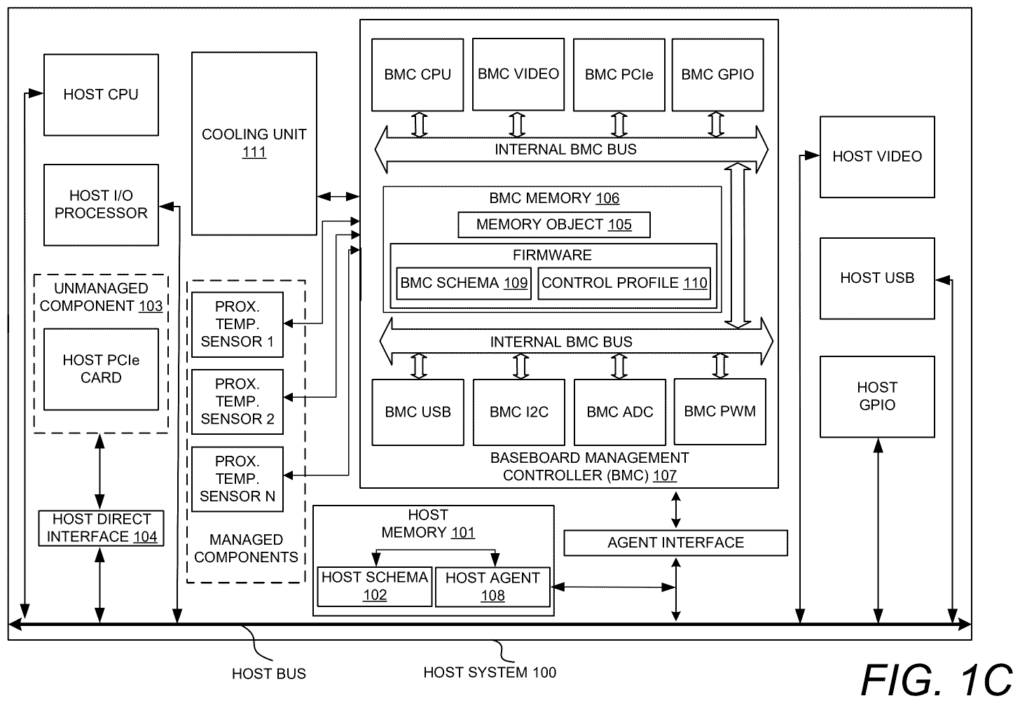

FIGS. 1A-1C illustrate a system for providing enhanced thermal management control for unmanaged components of a host system 100 via a baseboard management controller (“BMC”) 107. The techniques disclosed herein utilize a host schema 102 and a BMC schema 109, which can be identical copies that are both referred to herein as a schema. The schema defines parameters for controlling the collection of temperature data from internal temperature sensors of unmanaged components 103. The schema enables a host agent 108 of the host system 100 to coordinate with the BMC 107 and communicate the temperature data acquired from unmanaged components 103 to the BMC 107. Once the BMC 107 receives the temperature data, the BMC 107 communicates the temperature data to a control profile 110 to accurately control a cooling level of one or more cooling units 111 in the host system 100. In the embodiments shown, copies of the schema are uploaded to the memories of a host system 100 and a BMC 107. The host agent 108 acquires temperature data from unmanaged components 103 of the host system 100 and communicates the temperature data to the BMC 107 according to the schema. The BMC 107 receives the temperature data and stores it in at least one memory object 105 that a control profile 110 can access to process the temperature data and adjust a cooling level of a cooling unit 111 based on a cooling function.

As shown in FIG. 1A, a host system 100 includes system components and a BMC 107. The BMC 107 has its own components and operates independently within the host system 100 to manage aspects of the host system 100, such as thermal monitoring and management. The host system 100 components include both managed and unmanaged components. A managed component, such as a proximity sensor, is directly accessible by the BMC 107, and an unmanaged component 103, such as a PCIe card, is not directly accessible by the BMC 107. In the embodiment shown, a host agent 108 retrieves temperature data from at least one unmanaged component 103 via at least one host direct interface 104. The host agent 108 retrieves the temperature data from at least one unmanaged component 103 according to a copy of a schema stored in the host memory 101, hereinafter referred to as the “host schema” 102. In this embodiment, the host agent 108 exists as part of the interface between the host system 100 and the BMC 107. FIG. 1B shows an embodiment where the host agent 108 can exist as part of a component of the host system 100. FIG. 1C shows an embodiment where, the host agent 108 can exist within the memory 101 of host system 100.

The schema facilitates the coordination between the host system 100 and the BMC 107. For example, once the host agent 108 retrieves the temperature data from at least one unmanaged component, the BMC 107 receives the temperature data from the host agent 108 according to a copy of a schema stored in the memory 106 of the BMC 107, the BMC schema 109. The host schema 102 and BMC schema 109 are copies of each other that contain equivalent schema parameters 700, but the host schema 102 and the BMC schema 109 can be uploaded independently from one another via alternative upload methods as required by the configuration of the host system 100. The BMC 107 receives the temperature data from the host agent 108 and stores it in at least one memory object 105 in the BMC memory 106. A control profile 110 in the memory 106 of the BMC 107 can then access the temperature data to adjust the cooling level of a cooling unit 111 of the host system 100 based on a cooling function.

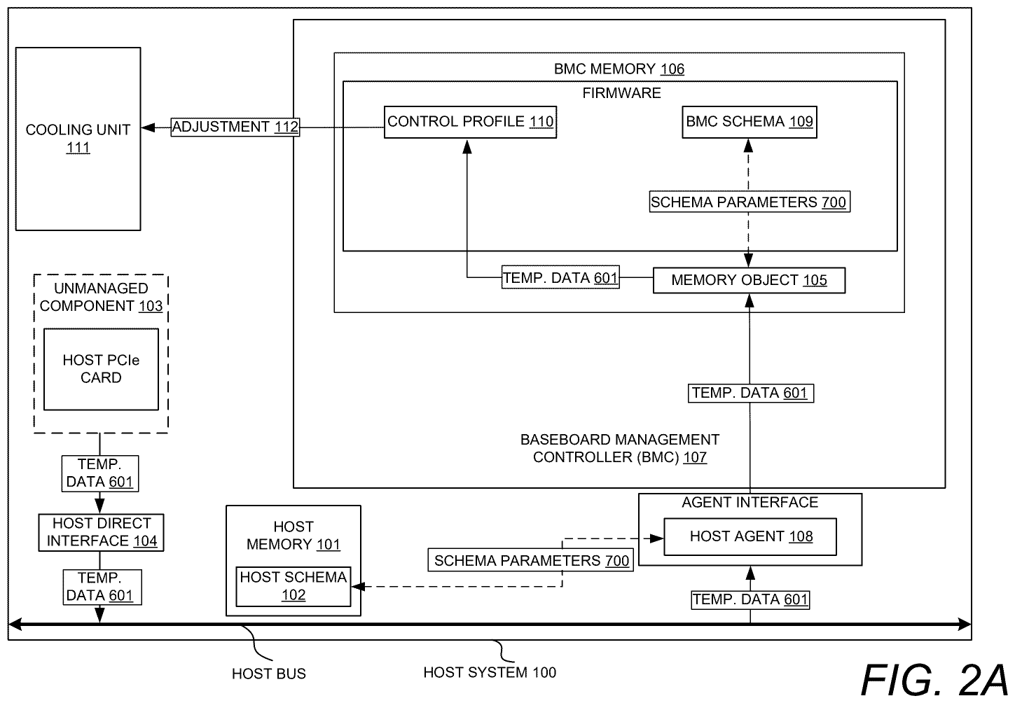

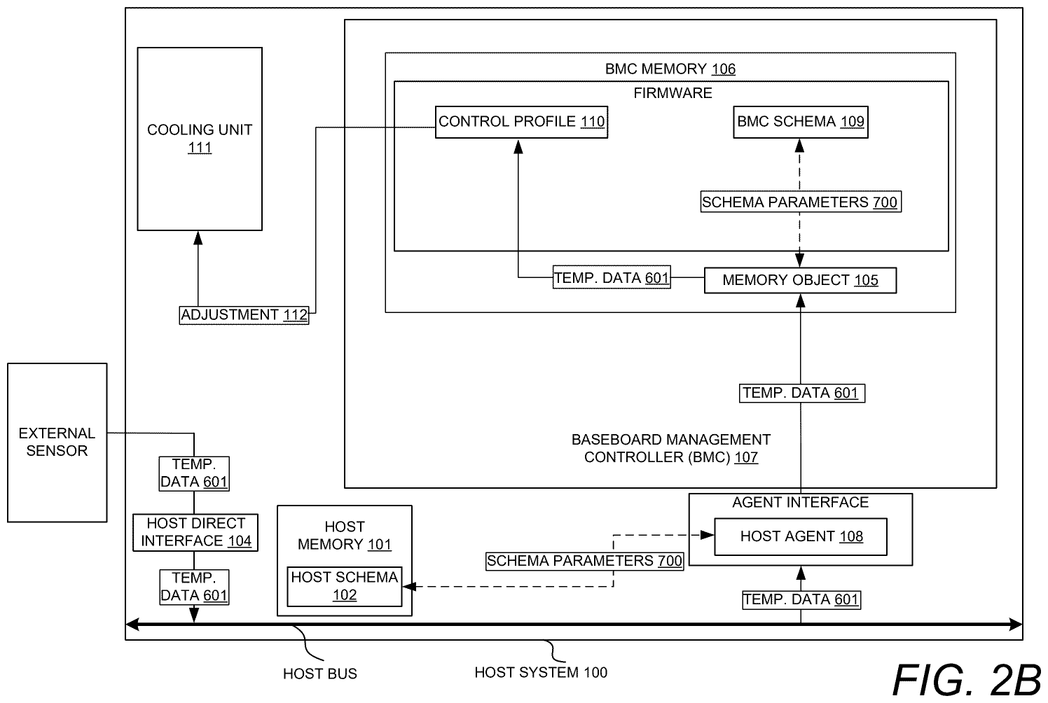

FIG. 2A shows how the temperature data 601 of the unmanaged component 103 is communicated through the host system 100. Specifically, FIG. 2A shows a PCIe card as an exemplary unmanaged component 103 of the host system 100 that is generating temperature data 601 via internal sensors. The host agent 108 retrieves the temperature data 601 from the PCIe card sensors through a host direct interface 104 according to the schema parameters 700 defined in the host schema 102. The host direct interface 104 can be PCIe, USB, SATA, or any other type of data interface used by a computer system. The host agent 108 then communicates the temperature data 601 to the BMC 107. The BMC 107 receives the temperature data 601 and stores it in at least one virtual memory object 105 in the BMC memory 106 according to the schema parameters 700 defined in the BMC schema 109. A control profile 110 in the memory 106 of the BMC 107 can access the temperature data 601 stored in the memory object 105 and process it according to a cooling function to make an adjustment 112 to a cooling unit 111 of the host system 100.

FIG. 2B shows an alternative embodiment where sensors external to the host system 100, such as sensors located within a data center or another computer system, are communicating temperature data 601 to the host system 100 and the BMC 107. The control profile 110 can access the appropriate memory object 105 and process the external sensor temperature data 601 to make an adjustment 112 to the cooling level 602 of the cooling unit 111 based on the cooling function 600. The schema parameters 700 and control profile 110 can also be configured to allow the BMC to make use of other types of unmanaged sensor data, e.g., data related to air pressure, humidity, or other environmental conditions, to manage aspects of the host system 100.

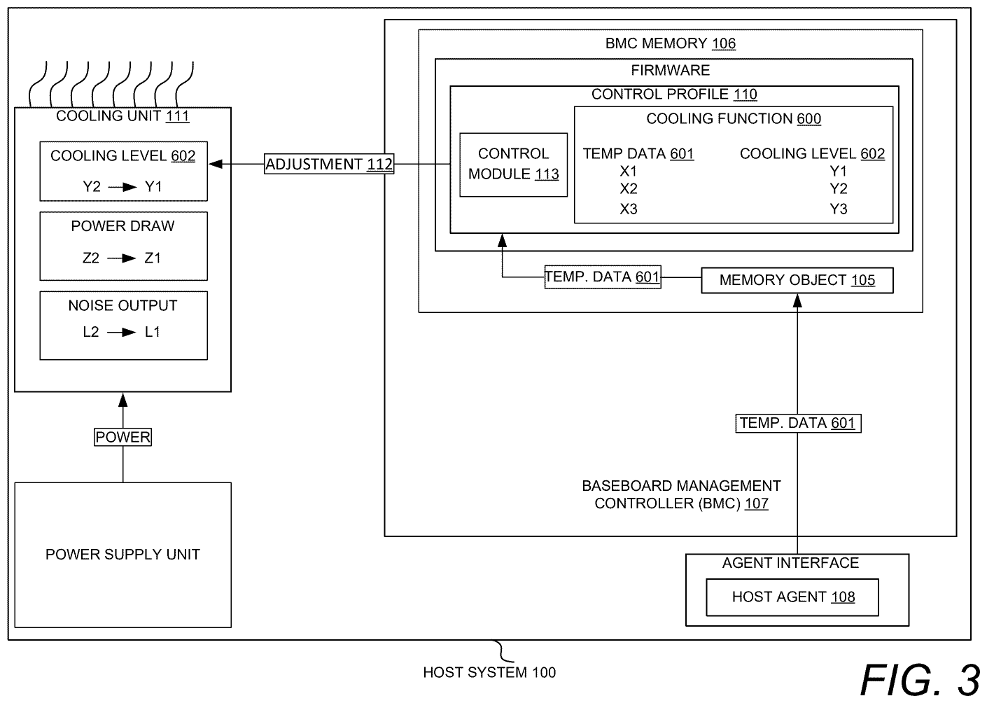

FIG. 3 shows the control profile 110 of the BMC 107 accessing temperature data 601 stored in a memory object 105 of the BMC 107 in greater detail. The control profile 110 includes a cooling function 600, which can be represented as a chart of corresponding values or a plotted curve, and a control algorithm, hereinafter referred to as the control module 113. The control module 113 reads the temperature data 601, determines the corresponding value for a cooling level 602 based on the cooling function 600, and makes an adjustment 112 to the cooling level 602 of the cooling unit 111 based on the corresponding cooling level 602 value. As shown, the increased accuracy from using temperature data 601 from unmanaged component 103 allows the control profile 110 to avoid overcooling the host system 100 by selecting a lower cooling level 602 that still provides sufficient cooling to the components of the host system 100. This lower cooling level 602 results in corresponding decreases to the power draw and noise output of the cooling unit 111.

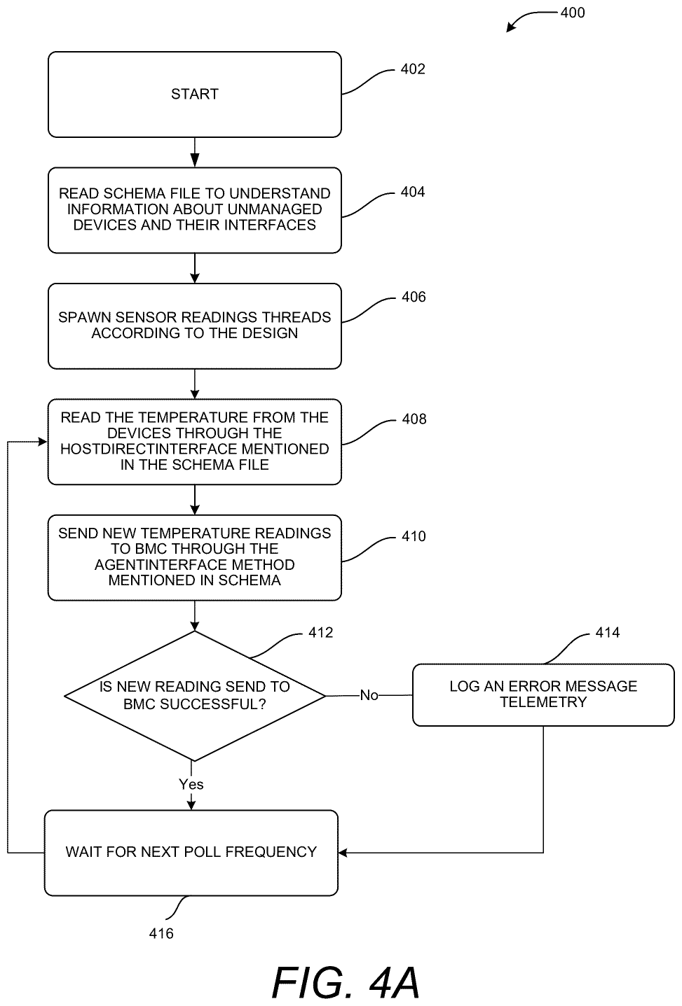

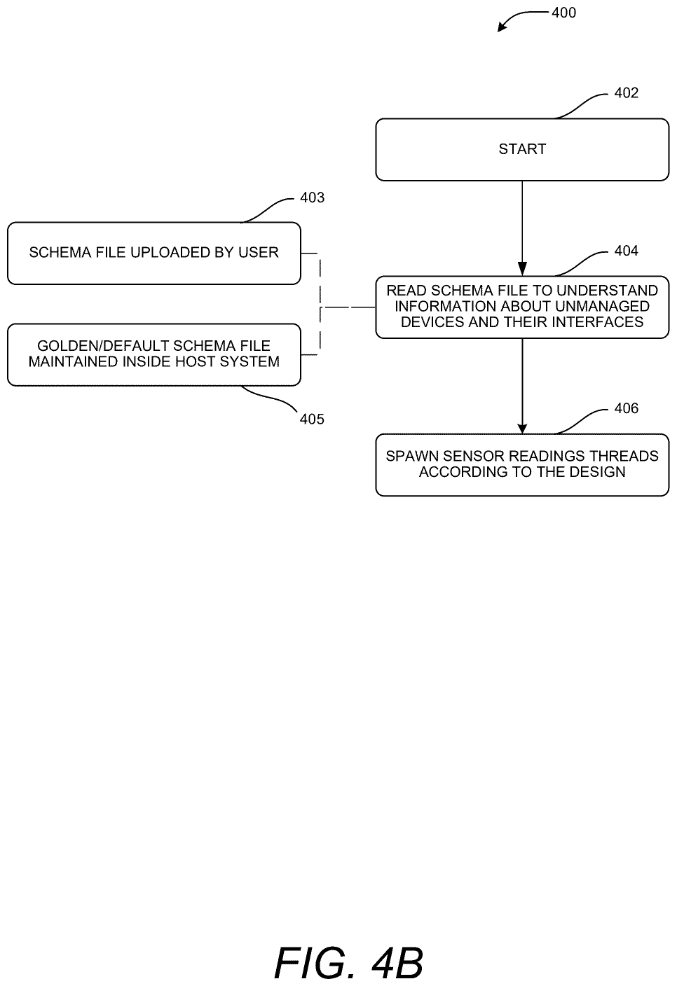

FIG. 4A is a flow diagram showing aspects of a routine 400 that causes a host agent 108 to collect temperature data 601 from at least one unmanaged component 103 of a host system 100. The routine 400 begins with operation 402, which is the start of the runtime execution of the host agent 108. At operation 404, and as discussed in greater detail below, the host agent 108 reads either a schema file uploaded by a user, or a default “golden” schema file maintained inside the host system 100 to obtain information about at least one unmanaged component 103, sometimes referred to as an unmanaged “device,” and at least one corresponding interface, sometimes referred to as a “host direct interface” 104. At operation 406, the host agent 108 spawns any necessary threads or initializations according to a design, such as the host schema 102. At operation 408, the host agent 108 reads the temperature data 601 from at least one unmanaged component 103 through at least one host direct interface 104 as specified in the host schema 102. At operation 410, the host agent 108 sends the temperature data 601 to the BMC 107 through the agent interface method, e.g., IPMI or Redfish, mentioned in the host schema 102. At operation 412, the host agent 108 determines if the temperature data 601 was successfully communicated to the BMC 107. If communication of the temperature data 601 to the BMC 107 was unsuccessful, the routine 400 proceeds from operation 412 to operation 414, where the host agent 108 logs error message telemetry. The routine 400 then proceeds from operation 414 to operation 416, where the host agent waits for the next poll frequency 703 before proceeding back to operation 408. Returning to operation 412, if the host agent 108 determines communication of the temperature data 601 to the BMC 107 was successful, the routine 400 proceeds from operation 412 to operation 416, and the host agent 108 waits for the next poll frequency 703 defined by the host schema 102 before the routine 400 returns to operation 408.

FIG. 4B is a flow diagram showing additional details of operation 404 of the routine 400. At operation 404, the host agent 108 reads either a user-uploaded schema file provided during operation 403 or a default “golden” schema file maintained inside the host system 100 as part of operation 405. The user-uploaded schema can be uploaded to the host system 100 at runtime. The golden schema file specifies a minimum set of unmanaged components expected to be present in an operational host system 100. For example, a host system 100 can be required to include RAM and at least one storage drive. The golden schema file can be used to verify if the host meets these requirements. The golden schema file also ensures the host agent 108 can retrieve temperature data 601 from the specified set of unmanaged components 103 in the absence of a schema file uploaded by a user.

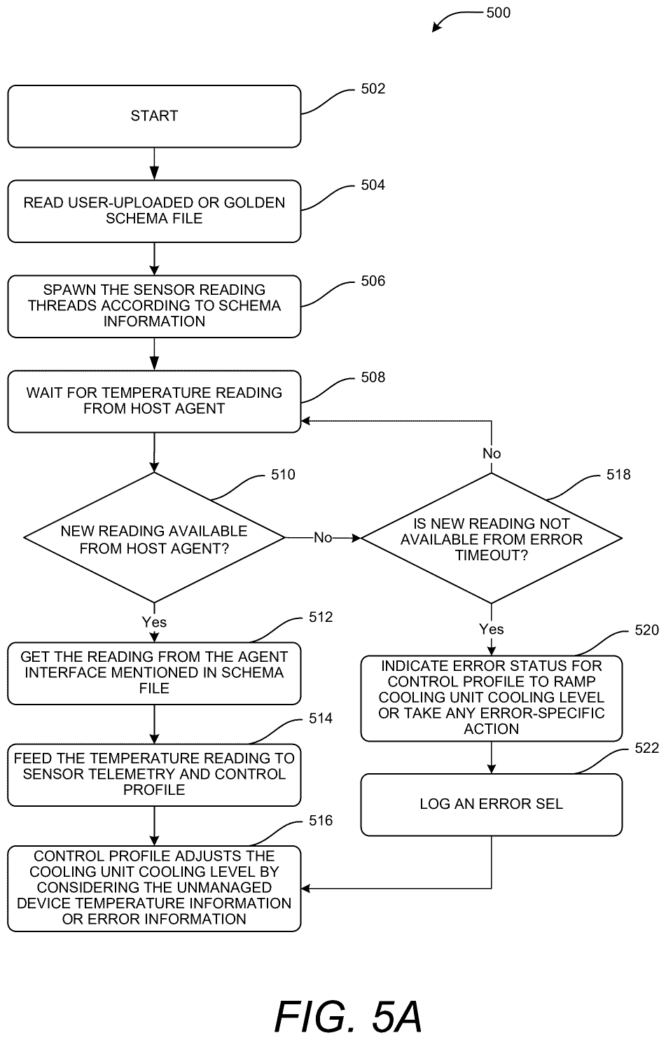

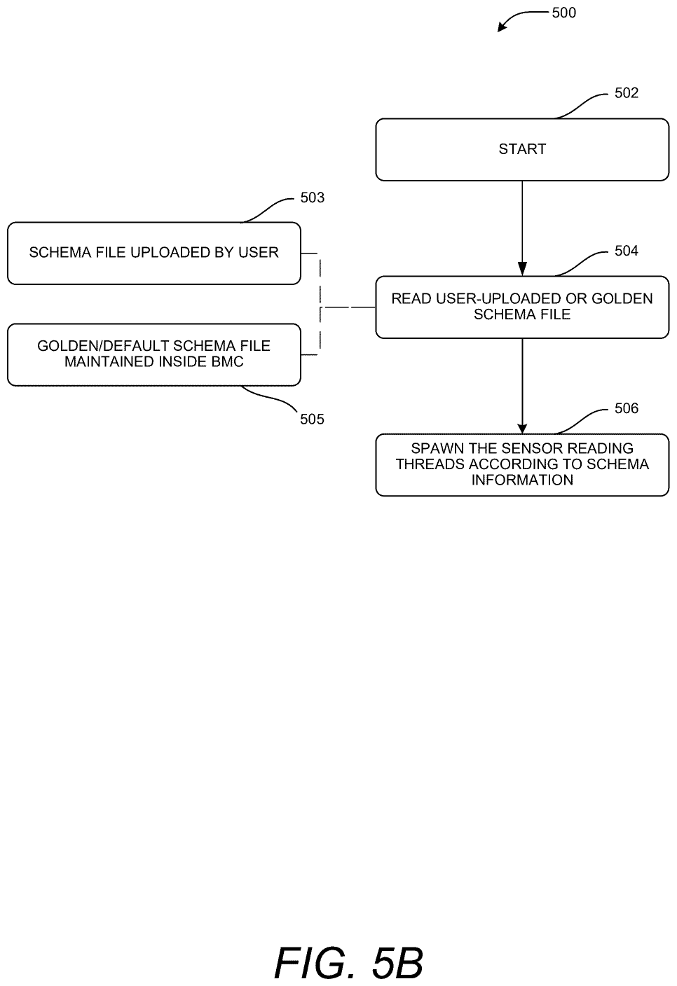

FIG. 5A is a flow diagram showing aspects of a routine 500 that causes a BMC 107 to receive temperature data 601 from at least one unmanaged component 103 of a host system 100 via a host agent 108. The routine 500 begins with operation 502, which marks the start of the operational state of the BMC 107. At operation 504, and as discussed in greater detail below, the BMC 107 reads either a schema file uploaded by a user, or a default “golden” schema file maintained inside the BMC 107. At operation 506, the BMC 107 spawns sensor reading threads according to the BMC schema 109. At operation 508, the BMC 107 waits to receive temperature data 601 from the host agent 108 according to the BMC schema 109. At operation 510, the BMC determines if new temperature data 601 is available from the host agent 108. If new temperature data 601 is available from the host agent 108, the routine 500 proceeds to operation 512, and the BMC 107 receives the temperature data 601 from the agent interface defined in the BMC schema 109.

At operation 514, the BMC communicates the temperature data 601 to sensor telemetry and the control profile 110. At operation 516, the control profile 110 adjusts the cooling unit 111 by processing the temperature data 601 from the unmanaged components 103. Returning to operation 510, if new temperature data 601 is not available from the host agent 108, the routine 500 proceeds from operation 510 to operation 518, where the BMC 107 determines if the new temperature data 601 is not available from error timeout. If the new temperature data 601 is not available due to an error timeout, the routine 500 proceeds from operation 518 to operation 520, where the BMC 107 indicates an error status for the control profile 110 to increase the cooling level 602 of the cooling unit 111 or take any other error-specific action. Next, the routine 500 proceeds from operation 520 to operation 522, where the BMC 107 logs an error SEL. The routine 500 then proceeds from operation 522 to operation 516, where the control profile 110 adjusts the cooling unit 111 by processing the error message from operation 520. Returning to operation 518, if new temperature data 601 is not available and an error timeout has not occurred, the routine 500 proceeds from operation 518 to operation 508, where the BMC 107 waits for new temperature data 601 from the host agent 108 according to the BMC schema 109.

FIG. 5B is a flow diagram showing additional details of operation 504 of the routine 500. At operation 504, the BMC 107 reads either a user-uploaded schema file provided during operation 503 or a default “golden” schema file maintained inside the BMC as part of operation 505. The user-uploaded schema can be uploaded to the BMC 107 at runtime. The golden schema file specifies a minimum set of unmanaged components expected to be present in an operational host system 100. For example, a host system 100 can be required to include RAM and at least one storage drive. The golden schema file can be used to verify if the host meets these requirements. The golden schema file also ensures the BMC 107 can monitor the specified set of unmanaged components 103 in the absence of a schema file uploaded by a user.

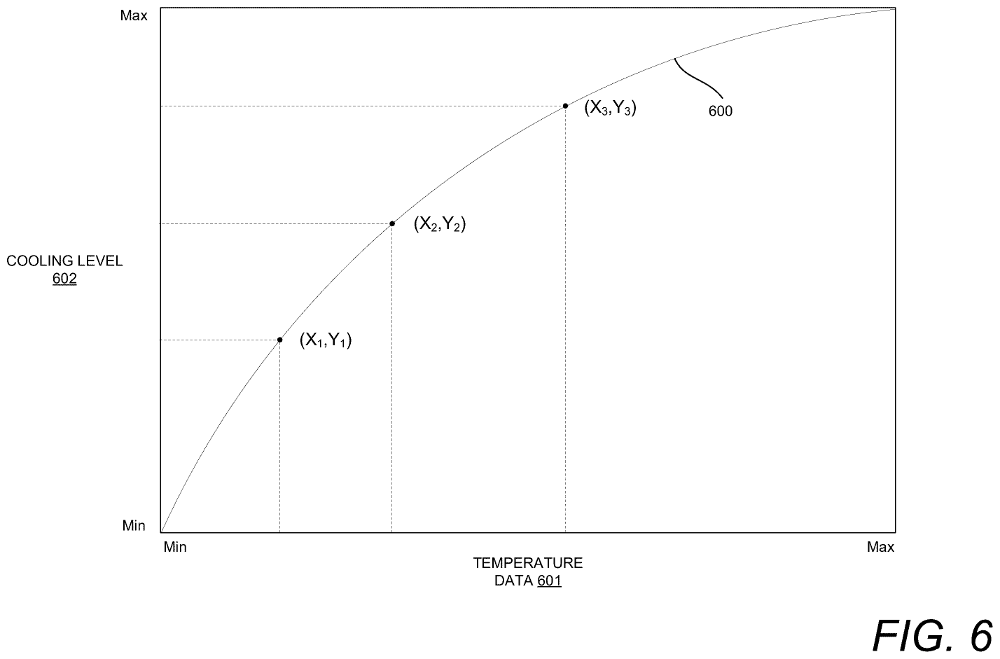

FIG. 6 shows an example cooling function 600 of a control profile 110 that specifies a relationship between a cooling level 602 of a cooling unit 111 and temperature data 601 from at least one unmanaged component 103 of a host system 100. The control profile 110 accesses the temperature data 601 stored in at least one memory object 105 within the memory 106 of the BMC 107 and uses the cooling function 600 to determine the cooling level 602 for the cooling unit 111 that corresponds to the temperature data 601. The control profile 110 then adjusts the cooling level 602 of the cooling unit 111 to ensure the cooling level 602 of the cooling unit 111 matches the cooling level 602 that was determined based on the cooling function 600.

In some embodiments, the control profile 110 may be a fan logic and the cooling unit 111 a system fan. The fan logic accesses the temperature data 601 stored in at least one virtual memory object 105, determines an appropriate cooling level 602 based on the cooling function 600, and makes an adjustment 112 to change the speed of the fan and alter the air flow within the host system 100. In a second embodiment, the control profile 110 may include pump logic and the cooling unit 111 can be a liquid coolant pump. The pump logic accesses the temperature data 601 stored in at least one virtual memory object 105, determines an appropriate cooling level 602 based on the cooling function 600, and makes and adjustment 112 to change the speed of the pump to alter the flow of liquid coolant circulating through a cooling loop in the host system 100. In a third embodiment, the control profile 110 may be a vent actuator logic and the cooling unit 111 a vent aperture. The vent actuator logic accesses the temperature data 601 stored in at least one virtual memory object 105, determines an appropriate cooling level 602 based on a cooling function 600, and makes an adjustment 112 to change the position of a vent actuator to alter a vent aperture and change the air flow within the host system 100. In a fourth embodiment, the control profile 110 may be an electric current control logic and the cooling unit 111 a thermoelectric cooler. The electric current control logic accesses the temperature data 601 stored in at least one virtual memory object 105, determines an appropriate cooling level 602 based on a cooling function 600, and makes an adjustment 112 to change the current supplied to a thermoelectric cooler and alter the temperature of a cooling surface within the host system 100.

The above embodiments are provided as examples, and the control profile 110 can be configured to adjust other types of electronically controllable cooling units for thermally managing the host system 100. The control profile 110 may also be configured to adjust one or more cooling units, or one or more types of cooling units, either sequentially or simultaneously. Additionally, the system may also be configured to make use of multiple control profiles to manage cooling units of the host system 100 more effectively.

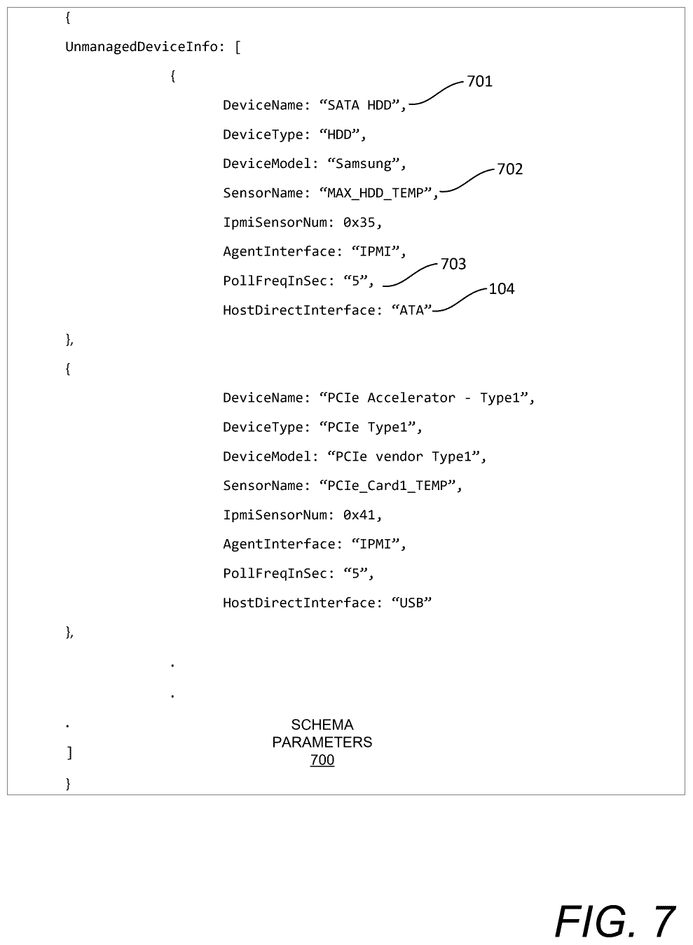

FIG. 7 shows JSON data related to schema parameters for enhanced thermal management control for unmanaged components in a host system. More specifically, FIG. 7 shows schema parameters 700 defined by the host schema 102 and BMC schema 109. The schema parameters 700 define at least one identifier 701 of at least one unmanaged component 103 of the host system 100, at least one host direct interface 104 from which the host agent 108 receives temperature data 601 from an unmanaged component 103, at least one identifier 702 for at least one memory object 105 storing temperature data 601 from an unmanaged component 103, and at least one poll frequency 703 specifying how often to receive temperature data 601 from at least one unmanaged component 103. The host agent 108 and the BMC 107 use the schema parameters 700 to ensure the host agent retrieves temperature data 601 from the correct component of the host system 100 at the correct frequency and stores it in the correct virtual memory object 105 of the BMC 107.

Although the subject matter presented herein has been described in language specific to computer structural features, methodological acts, and computer readable media, it is to be understood that the present invention is not necessarily limited to the specific features, acts, or media described herein. Rather, the specific features, acts and mediums are disclosed as example forms.

The following clauses are to supplement the present disclosure. Clause A pertains to FIGS. 1A-1C, and 2A. Clause A is directed to a host agent receiving a schema that defines parameters for collecting temperature data from unmanaged components. The host agent collects the temperature data according to schema copy stored in the host system's memory and communicates the temperature data to a BMC. Communication of the temperature data from the host agent to the BMC causes the BMC to process the temperature data according to a schema copy stored in the BMC's memory and adjust a cooling level of a cooling unit based on a control profile in the firmware of the BMC.

The present disclosure is supplemented with the following clauses:

Clause A. A method for increasing cooling efficiency and reducing power consumption of a host system (100), the method comprising: receiving, in a memory (101) of the host system (100), a first schema (102) defining parameters (700) for collecting temperature data (601) from at least one unmanaged component (103) of the host system (100), FIGS. 1A, 4B and para. 0034: FIG. 1A shows the system with a copy of the schema in the host memory, FIG. 4B shows the operation of the schema file being uploaded. Para 0034 describes the schema file as either a user-uploaded file or a golden schema stored in the memory of the host system, wherein the parameters (700) include: at least one identifier (701) of the at least one unmanaged component (103), and at least one interface (104) from which to receive the temperature data (601) from the at least one unmanaged component (103), and at least one poll frequency (703) specifying how often to receive the temperature data (601) from the at least one unmanaged component (103), and at least one identifier (702) for at least one memory object (105) storing the temperature data (601) received from the at least one unmanaged component (103), wherein the at least one memory object (105) is stored in a memory (106) of a baseboard management controller (107) of the host system (100); FIG. 7 and para. 0038: FIG. 7 shows JSON data listing the schema parameters defined by the schema for collecting unmanaged component temperature data. Para. 0038 describes the schema parameters shown in FIG. 7; collecting, by a host agent (108) of the host system (100) using the at least one interface (104), the temperature data (601) from the at least one unmanaged component (103), wherein the host agent (108) collects the temperature data (601) in accordance with the at least one identifier (701) of the at least one unmanaged component (103) and the at least one poll frequency (703), using the at least one identifier (702) for at least one memory object (105) of a second schema (109), of the first schema (102); FIG. 2A, paras. 0031 and 0038: FIG. 2A shows the host agent is collecting temperature data from an unmanaged component through a host direct interface and storing it in a memory object in the BMC. Para. 0031 describes the temperature data being collected and stored according to the host schema and the BMC schema. Para. 0038 describes the parameters defined by the schema; and communicating the temperature data (601) collected by the host agent (108) to the baseboard management controller (107), causing the baseboard management controller (107) to process the temperature data (601) according to the second schema (109) stored in the memory (106) of the baseboard management controller (107), the temperature data (601) processed according to the second schema (109) to prevent overcooling of the host system (100) and reduce power consumption of the host system (100) by adjusting a cooling unit (111) of the host system (100) according to a control profile (110) that defines a cooling level (602) relative to a measurement of the temperature data (601). FIGS. 2A and 3: FIG. 2A shows details of the temperature data being communicated from the host agent to a memory object in the BMC, where it is used by the control profile to make an adjustment to the cooing unit. FIG. 3 shows details of the control profile defining the cooling level of the cooling unit relative to temperature data, as well as the decreased cooling level, power draw, and noise level associated with use of the more accurate temperature data from the unmanaged components.

Clause B: The method of Clause A, wherein adjusting the cooling unit (111) includes, adjusting at least one of a fan speed, a pump speed, a vent aperture, or a thermoelectric current according to a function (600) of the control profile (110) that correlates the temperature data (601) with a corresponding fan speed, pump speed, vent aperture, or thermoelectric current. FIGS. 3 and 6, and para. 0037: FIG. 3 shows the cooling function as part of the control profile in chart form, as well as the cooling level of the cooling unit being adjusted by the control profile according to cooling function. FIG. 6 shows the cooling function of the control profile as a plotted curve. Para. 0037 describes how the cooling unit can be a fan, a liquid coolant pump, a vent aperture, or a thermoelectric cooler.

Clause C: the method of Clauses A-B, wherein the first schema is received in the memory (101) of the host system (100) at runtime. Para. 0034: the host system can accept schema file uploads during runtime.

Clause D: The method of Clauses A-C, wherein the second schema (109) defines an identifier (701) of the at least one unmanaged component (103), a poll frequency (703), and an identifier (702) for at least one memory object (105), wherein at least one of the identifier (701) of the at least one unmanaged component (103), the poll frequency (703), or the identifier (702) of the at least one memory object (105) is used to validate communication of temperature data (601) from the host agent (108) to the baseboard management controller (107). Para. 0010: Describes how the identical copies of the schema in the host memory and the BMC memory enable the host agent and the BMC to coordinate based on the schema parameters to ensure the correct temperature data is being retrieved by the host agent, communicated to the BMC, and stored for access by the control profile.

Clause E: The method of Clauses A-D, wherein the first schema (102) and the second schema (109) have identical parameters (700). Para. 0030: Describes the schema in the BMC memory and the host memory as identical copies of each other with equivalent parameters.

Clause F: The method of Clauses A-E, wherein the first schema (102) defines at least one additional parameter for collecting data from at least one sensor external to the host system (100). FIG. 2B and para. 0031: FIG. 2B shows the host agent is collecting temperature data from sensors external to the host system and communicating that temperature data to the BMC, where it is used by the control profile to make an adjustment to the cooling unit. Para. 0031 describes how the schema parameters can be configured to also allow the BMC to receive environmental data from sensors outside the host system and adjust the host system accordingly.

Clause F: The method of Clauses A-E, wherein processing the temperature data (601) causes the baseboard management controller (107) to adjust at least one additional cooling unit according to the control profile (110). Para. 0037 describes how the system can contain more than one cooling unit or more than one type of cooling unit (e.g., a pump for liquid coolant and fans for radiator).

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

I/We claim:

1. A method for increasing cooling efficiency and reducing power consumption of a host system, the method comprising:
receiving, in a memory of the host system, a first schema defining parameters for collecting temperature data from at least one unmanaged component of the host system, wherein the parameters include:
at least one identifier of the at least one unmanaged component, and
at least one interface from which to receive the temperature data from the at least one unmanaged component, and
at least one poll frequency specifying how often to receive the temperature data from the at least one unmanaged component, and
at least one identifier for at least one memory object storing the temperature data received from the at least one unmanaged component, wherein the at least one memory object is stored in a memory of a baseboard management controller of the host system;
collecting, by a host agent of the host system using the at least one interface, the temperature data from the at least one unmanaged component, wherein the host agent collects the temperature data in accordance with the at least one identifier of the at least one unmanaged component and the at least one poll frequency, using the at least one identifier for at least one memory object of a second schema, of the first schema; and
communicating the temperature data collected by the host agent to the baseboard management controller, causing the baseboard management controller to process the temperature data according to the second schema stored in the memory of the baseboard management controller, the temperature data processed according to the second schema to prevent overcooling of the host system and reduce power consumption of the host system by adjusting a cooling unit of the host system according to a control profile that defines a cooling level relative to a measurement of the temperature data.

2. The method of claim 1, wherein adjusting the cooling unit includes, adjusting at least one of a fan speed, a pump speed, a vent aperture, or a thermoelectric current according to a function of the control profile that correlates the temperature data with a corresponding fan speed, pump speed, vent aperture, or thermoelectric current.

3. The method of claim 1, wherein the first schema is received in the memory of the host system at runtime.

4. The method of claim 1, wherein the second schema defines an identifier of the at least one unmanaged component, a poll frequency, and an identifier for at least one memory object, wherein at least one of the identifier of the at least one unmanaged component, the poll frequency, or the identifier of the at least one memory object is used to validate communication of temperature data from the host agent to the baseboard management controller.

5. The method of claim 1, wherein the first schema and the second schema have identical parameters.

6. The method of claim 1, wherein the first schema defines at least one additional parameter for collecting data from at least one sensor external to the host system.

7. The method of claim 1, wherein processing the temperature data causes the baseboard management controller to adjust at least one additional cooling unit according to the control profile.

8. A method for increasing cooling efficiency and reducing power consumption of a host system, the method executed on a baseboard management controller of the host system, the method comprising:
receiving, in a memory of the baseboard management controller of the host system, a first schema defining parameters for collecting temperature data from at least one unmanaged component of the host system, wherein the parameters define:
at least one identifier of the at least one unmanaged component, and
at least one interface from which to receive the temperature data from the at least one unmanaged component, and
at least one poll frequency specifying how often to receive the temperature data from the at least one unmanaged component, and
at least one identifier for at least one memory object for storing the temperature data received from the at least one unmanaged component, wherein the at least one memory object is stored in the memory of the baseboard management controller of the system; and
receiving, at the baseboard management controller, temperature data collected by a host agent of the host system according to a second schema, wherein receiving the temperature data from the host agent causes the baseboard management controller to prevent overcooling of the host system and reduce power consumption of the host system by adjusting a cooling unit of the host system according to a control profile.

9. The method of claim 8, wherein adjusting the cooling unit includes, adjusting at least one of a fan speed, a pump speed, a vent aperture, or a thermoelectric current according to a function of the control profile that correlates the temperature data with a corresponding fan speed, pump speed, vent aperture, or thermoelectric current.

10. The method of claim 8, wherein the first schema is received in the memory of the baseboard management controller during runtime.

11. The method of claim 8, wherein the second schema defines an identifier of the at least one unmanaged component, a poll frequency, and an identifier of the at least one memory object, wherein at least one of the identifier of the at least one unmanaged component, the poll frequency, or the identifier of the at least one memory object is used to validate communication of temperature data from the host agent to the baseboard management controller.

12. The method of claim 8, wherein the first schema and the second schema have equivalent parameters.

13. The method of claim 8, wherein the first schema defines another set of parameters for collecting environmental data from sensors external to the host system.

14. The method of claim 8, wherein processing the temperature data causes the baseboard management controller to adjust at least one additional cooling unit according to the control profile.

15. A system for increasing cooling efficiency and reducing power consumption of a host system, comprising:
one or more processing units; and
a computer-readable storage medium having encoded thereon computer executable instructions to cause the one or more processing units to:
receive, in a memory of the host system, a first schema defining parameters for collecting temperature data from at least one unmanaged component of the host system, wherein the parameters define:
at least one identifier of the at least one unmanaged component, and
at least one interface from which to receive the temperature data from the at least one unmanaged component, and
at least one poll frequency specifying how often to receive the temperature data from the at least one unmanaged component, and
at least one identifier for at least one memory object storing the temperature data received from the at least one unmanaged component, wherein the at least one memory object is stored in a memory of a baseboard management controller of the host system;
collect, by a host agent of the host system using the at least one interface, the temperature data from the at least one unmanaged component, wherein the host agent collects the temperature data in accordance with the at least one identifier of the at least one unmanaged component and the at least one poll frequency, using the at least one identifier for at least one memory object of a second schema, of the first schema; and
communicate the temperature data collected by the host agent to the baseboard management controller, wherein the temperature data causes the baseboard management controller to process the temperature data according to the second schema stored in the memory of the baseboard management controller, the temperature data processed according to the second schema to prevent overcooling of the host system and reduce power consumption of the host system by adjusting a cooling unit of the host system according to a control profile that defines a cooling level relative to a measurement of the temperature data.

16. The system of claim 15, wherein the control profile defines a function of the temperature data and the cooling level provided by the cooling unit, wherein the cooling level includes at least one of a fan speed, a pump speed, a vent aperture, or a thermoelectric current.

17. The system of claim 15, wherein the second schema defines an identifier of the at least one unmanaged component, a poll frequency, and an identifier for at least one memory object, wherein at least one of the identifier of the at least one unmanaged component, the poll frequency, or the identifier of the at least one memory object is used to validate accurate communication of temperature data from the host agent to the baseboard management controller.

18. The system of claim 15, wherein the first schema and the second schema have equivalent parameters.

19. The system of claim 15, wherein the first schema defines another set of parameters for collecting environmental data from sensors external to the host system.

20. The system of claim 15, wherein processing the temperature data causes the baseboard management controller to adjust at least one additional cooling unit according to the control profile.
